(19) United States
(12) Patent Application Publication
(10) Pub. No.: US 2025/0187955 A1
(43) Pub. Date: Jun. 12, 2025

(54) WATER TREATMENT DEVICE AND WATER TREATMENT METHOD

(71) Applicant: ORGANO CORPORATION, Tokyo (JP)

(72) Inventors: Tsukasa KONDO, Tokyo (JP); Fumitaka ICHIHARA, Tokyo (JP)

(73) Assignee: ORGANO CORPORATION, Tokyo (JP)

(21) Appl. No.: 18/844,159

(22) PCT Filed: Jan. 23, 2023
(86) PCT No.: PCT/JP2023/001881

§ 371 Date: Sep. 5, 2024

(30) Foreign Application Priority Data
Mar. 14, 2022 (JP) 2022-039136
Aug. 8, 2022 (JP) 2022-126268

(51) Int. Cl. C02F 1/70; B01J 23/42; C02F 1/00; C02F 1/32; C02F 101/10; C02F 103/04

(52) U.S. Cl. CPC C02F 1/70; B01J 23/42; C02F 1/008; C02F 1/32; C02F 2101/10; C02F 2103/04; C02F 2209/22; C02F 2209/30

(57) ABSTRACT

A water treatment device includes an oxidizing substance removal device removing oxidizing substances from water to be treated. The oxidizing substance removal device includes: a hydrogen adder adding hydrogen to the water to be treated; a catalyst tower with a platinum group metal-supported catalyst through which the water to be treated to which hydrogen has been added passes; a control unit that controls an additive amount of hydrogen; and a first meter measuring the dissolved hydrogen concentration in the outlet water of the catalyst tower. A layer height of a packed material in the catalyst tower, including the platinum group metal-supported catalyst, is 10 cm or more, and the control unit performs a first additive amount control that controls the additive amount of hydrogen so that a measured value by the first meter is within a first range.

### TECHNICAL FIELD

The present invention relates to a water treatment device and a water treatment method for producing ultrapure water and the like.

### BACKGROUND ART

Ultrapure water, from which impurities are highly removed, is used in many fields, for example, as water for cleaning silicon wafers in the semiconductor manufacturing process. When ultrapure water is used as cleaning water for silicon wafers, oxidizing substances such as oxygen (O₂) and hydrogen peroxide (H₂O₂) dissolved in the ultrapure water cause formation of a natural oxide film on the surface of the silicon wafer. Therefore, a method of removing oxidizing substances by using a platinum group metal-supported catalyst, in which a platinum group metal represented by palladium (Pd) or platinum (Pt) is supported on a carrier, has been proposed for the production of ultrapure water. By using the platinum group metal-supported catalyst, not only can hydrogen peroxide be decomposed and removed by the reaction represented by the following formula (1), but also oxygen contained in water to be treated can be removed by the reaction of oxygen in the copresence of hydrogen (H₂), as shown in formula (2) below.

2H₂O₂→2H₂O+O₂ (1)

2H₂+O₂→2H₂O (2)

Oxygen is generated when the platinum group metal-supported catalyst decomposes hydrogen peroxide, but this oxygen can also be removed by reacting with hydrogen in the presence of the platinum group metal-supported catalyst. When removing oxygen and hydrogen peroxide from water to be treated using a platinum group metal-supported catalyst, the water to be treated must contain hydrogen, and hydrogen is added to the water to be treated as needed.

Patent Literature 1 discloses that, in order to reduce the dissolved oxygen (DO) concentration in the water to be treated which is supplied to an ultraviolet oxidation device that decomposes and removes total organic carbon (TOC) components in a ultrapure water production apparatus, an oxygen removal device with a platinum group metal-supported catalyst is installed between a deionization device and the ultraviolet oxidation device, and that hydrogen is added to the water to be treated which is supplied from the deionization device to the oxygen removal device in an amount equal to or greater than the equivalent amount. Patent Literature 1 further discloses that, in order to suppress the decrease in TOC removal efficiency in the ultraviolet oxidation device due to dissolved hydrogen (DH) when the outlet water, which contains hydrogen, from the oxygen removal device is supplied to the ultraviolet oxidation device, the dissolved hydrogen concentration of the outlet water of the oxygen removal device is measured to control the additive amount of hydrogen at the inlet side of the oxygen removal device so that the dissolved hydrogen concentration is 15 μg/L or less.

In the production of ultrapure water, the outlet water from the ultraviolet oxidation device that decomposes TOC components contains oxidizing substances such as oxygen and hydrogen peroxide. The oxidizing substances, especially hydrogen peroxide, accelerate the degradation of ion exchange resins in an ion exchange device, which is located at a subsequent stage of the ultraviolet oxidation device. Therefore, Patent Literature 2 discloses that hydrogen is added to the outlet water of the ultraviolet oxidation device before the treatment with a platinum group metal-supported catalyst, and the amount of hydrogen added is controlled so that the dissolved oxygen concentration in the water after the treatment is between 1 and 10 μg/L. The water treated with the platinum group metal-supported catalyst is supplied to a membrane degassing device for further removal of dissolved oxygen after the treatment in the ion exchange device.

In order to obtain ultrapure water with reduced dissolved oxygen concentration while controlling dissolved nitrogen (DN) concentration to a predetermined value, Patent Literature 3 discloses that nitrogen is added to the outlet water of the ultraviolet oxidation device while measuring the dissolved nitrogen concentration of the outlet water, and then the outlet water is subjected to addition of hydrogen and treatment with the platinum group metal-supported catalyst. The water treated with the platinum group metal-supported catalyst is then subjected to ion exchange treatment.

Patent Literature 4 discloses that in the production of ultrapure water, when hydrogen is added to outlet water of an ultraviolet oxidation device to remove oxidizing substances from the outlet water before treatment with a platinum group metal-supported catalyst, the dissolved hydrogen concentration of the water during or after passing through the platinum group metal-supported catalyst is measured and the amount of hydrogen added is controlled according to that measured value.

### CITATION LIST

### Patent Literature

Patent Literature 1: JP 2000-167593 A
Patent Literature 2: JP 2016-215150 A
Patent Literature 3: JP 2012-254428 A
Patent Literature 4: JP 2015-166064 A

### SUMMARY OF INVENTION

### Technical Problem

When hydrogen is added to water to be treated for removal of oxidizing substances in the water to be treated and then the water to be treated is treated with a platinum group metal-supported catalyst, it is preferable that the additive amount of hydrogen is greater than the theoretical value (i.e., equivalent amount) to generate water by reaction with both the oxygen originally contained in the water to be treated and the oxygen generated by the decomposition of hydrogen peroxide. On the other hand, if the additive amount of hydrogen is excessive and the water to be water which has been treated with the platinum group metal-supported catalyst also contains more than a certain amount of hydrogen, this is undesirable from the perspective of the quality of the ultrapure water obtained. In order to obtain ultrapure water of good quality, it is required that not only dissolved oxygen concentration but also dissolved hydrogen concentration are controlled to low values in the water treated with the platinum group metal-supported catalyst.

In the ultrapure water production apparatus described in Patent Literature 1, the additive amount of hydrogen is controlled according to the dissolved hydrogen concentration in the water treated with the platinum group metal-supported catalyst, but there is a problem that the targeted value of the dissolved hydrogen concentration is set at an upper limit of 15 μg/L, which is too high for some ultrapure water applications. Another issue is that the ultraviolet oxidation device is placed at a subsequent stage of the platinum group metal-supported catalyst, and oxidizing substances such as hydrogen peroxide generated by the ultraviolet oxidation device cannot be removed.

In the technique described in Patent Literature 2, since the additive amount of hydrogen is controlled based on the dissolved oxygen concentration, it is difficult to reduce the dissolved hydrogen concentration to an extreme level. In addition, since a membrane degassing device is installed at a subsequent stage of the platinum group metal-supported catalyst, equipment and maintenance costs increase. Similarly, in the technique described in Patent Literature 3, it is difficult to reduce the dissolved hydrogen concentration to the extreme limit, and there is a problem of increased cost due to installation of a membrane degassing device.

In the disclosure of Patent Literature 4, it is not clear to what extent the dissolved oxygen and dissolved hydrogen concentrations can be specifically reduced in the water treated with the platinum group metal-supported catalyst. With regard to applying the technique described in Patent Literature 4 to obtain high-quality ultrapure water with dissolved oxygen and hydrogen concentrations of, for example, 0.1 μg/L or less and hydrogen peroxide concentration of, for example, 1.0 μg/L or less, a further study is still required.

The problem in removing oxidizing substances in production of ultrapure water has been described. However, when producing water other than ultrapure water, such as various types of functional water, from water to be treated, there is also a need to remove oxidizing substances without increasing the concentration of dissolved hydrogen, and there is also a need to control the concentration of dissolved hydrogen while adding hydrogen to the water to be treated. Hereafter, processes used to obtain water with various properties and functions, including ultrapure water, from water to be treated are collectively referred to as water treatment.

The object of the present invention is to provide a water treatment device and a water treatment method that can be used, for example, to produce high-quality ultrapure water at low cost and that can remove oxidizing substances and control dissolved hydrogen concentration.

### Solution to Problem

The water treatment device according to the present invention includes an oxidizing substance removal device that removes an oxidizing substance from water to to be treated, wherein the oxidizing substance removal device includes: hydrogen adding means that adds hydrogen to the water to be treated; a catalyst tower equipped with a platinum group metal-supported catalyst through which the water to be treated to which hydrogen has been added passes; a control unit that controls an amount of hydrogen added by the hydrogen adding means; and first measuring means that measures a dissolved hydrogen concentration in outlet water of the catalyst tower, wherein a layer height of a packed material in the catalyst tower, including the platinum group metal-supported catalyst, is 10 cm or more, and wherein the control unit performs a first additive amount control that controls the amount of hydrogen added by the hydrogen adding means so that a measured value by the first measuring means is within a first range.

The water treatment method according to the present invention includes an oxidizing substance removal step that removes an oxidizing substance from water to be treated, wherein the oxidizing substance removal step includes the steps of: adding hydrogen to the water to be treated; and passing the water to be treated to which hydrogen has been added through a catalyst tower equipped with a platinum group metal-supported catalyst, wherein, in the step of adding hydrogen, a first additive amount control is performed to control an amount of hydrogen added to the water to treated so that a dissolved hydrogen concentration in outlet water of the catalyst tower is within the a first range, and wherein, in the catalyst tower, a layer height of a packed material in the catalyst tower, including the platinum group metal-supported catalyst, is 10 cm or more.

According to the present invention, removal of oxidizing substances and control of dissolved hydrogen concentration can be performed at low cost, and if the present invention is applied to the production of ultrapure water, for example, high-quality ultrapure water in which both dissolved oxygen concentration and dissolved hydrogen concentration are 0.1 μg/L or less and hydrogen peroxide concentration is 1 μg/L or less can be produced at low cost.

### BRIEF DESCRIPTION OF DRAWINGS

FIG. 1 is a view showing an ultrapure water production apparatus according to an embodiment of the present invention;

FIG. 2 is a view showing the apparatus used in Examples and Comparative Examples;

FIG. 3 is a graph showings the results of Example 1;

FIG. 4 is a graph showings the results of Comparative Example 1;

FIG. 5 is a graph showings the results of Example 2;

FIG. 6 is a graph showings the results of Example 3;

FIG. 7 is a graph showings the results of Example 4;

FIG. 8 is a graph showings the results of Example 5;

FIG. 9 is a graph showings the results of Example 6; and

FIG. 10 is a graph showings the results of Example 7.

### DESCRIPTION OF EMBODIMENTS

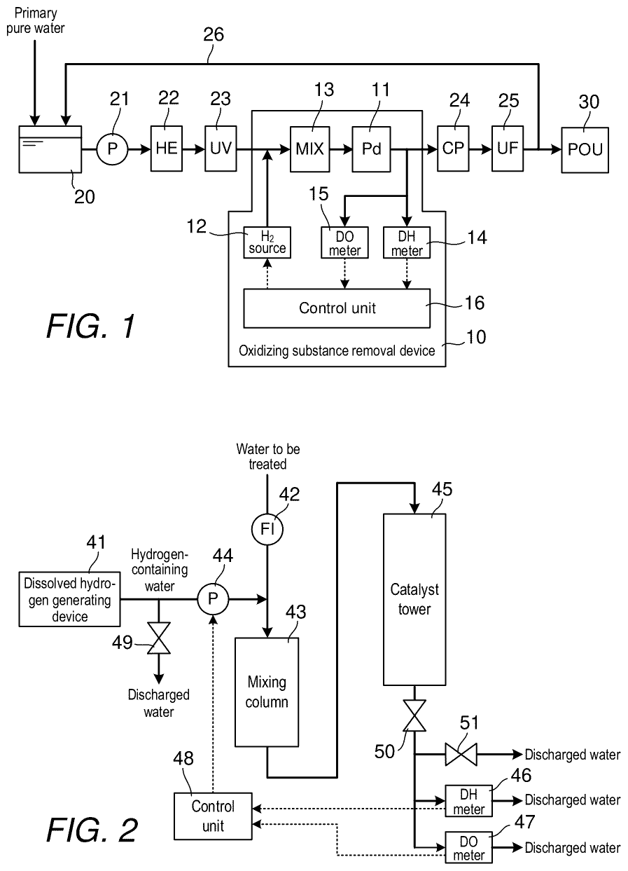

Next, the embodiments of the present invention will be explained with reference to the drawings. Here, we describe an example of a water treatment method based on the present invention applied to production of ultrapure water. FIG. 1 shows an ultrapure water production apparatus according to an embodiment of the present invention. The ultrapure water production apparatus shown in FIG. 1 is especially equipped with oxidizing substance removal device 10 and is configured as a subsystem (secondary pure water system) from which primary pure water is supplied from a pure water production apparatus (primary pure water system). This ultrapure water production apparatus supplies high-quality ultrapure water, for example, in which the dissolved oxygen (DO) and dissolved hydrogen (DH) concentrations are not more than 0.1 μg/L and the hydrogen peroxide concentration is not more than 1.0 μg/L, to point-of-use (POU) 30.

The ultrapure water production apparatus is equipped with: tank 20 that stores primary pure water as water to be treated; and pump 21 that feeds the water to be treated in tank 20. Heat exchanger (HE) 22, ultraviolet oxidation device (UV) 23, oxidizing substance removal device 10, non-regenerative mixed-bed ion exchange device (CP) 24, also called a cartridge polisher, and ultrafiltration membrane (UF) 25 are connected to the outlet of pump 21, i.e., at a secondary side of pump 21, in this order. In this ultrapure water production apparatus, the water to be treated stored in tank 20 is delivered by pump 21 and supplied to heat exchanger 22. The water to be treated that has been temperature-controlled by passing through heat exchanger 22 is fed to ultraviolet oxidation device 23. In ultraviolet oxidation device 23, the water to be treated is irradiated with ultraviolet light, and total organic carbon (TOC) components in the water to be treated are decomposed. The water to be treated, which is the outlet water of ultraviolet oxidation device 23, contains dissolved oxygen and hydrogen peroxide. The water to be treated containing oxidizing substances such as dissolved oxygen and hydrogen peroxide is then fed to oxidizing substance removal device 10, where the oxidizing substances in the water to be treated are removed. The water to be treated from which oxidizing substances have been removed is subjected to ion exchange treatment at non-regenerative mixed-bed ion exchange device 24 to remove metallic components, etc., and is further subjected to removal fine impurities at ultrafiltration membrane device 25. Part of the ultrapure water, which is the outlet water from ultrafiltration membrane device 25, is supplied to point-of-use 30, and the remaining ultrapure water not supplied to point-of-use 30 is returned to tank 20 via circulation piping 26. In this ultrapure water production apparatus, the ultrapure water not supplied to point-of-use 30 is further purified while circulating, so the purity of the ultrapure water obtained improves as time passes since the start of operation, and eventually the ultrapure water reaches a certain level of purity.

Devices generally used in a ultrapure water production apparatus provided as a subsystem, or secondary pure water system, can be used as tank 20, pump 21, heat exchanger 22, ultraviolet oxidation device 23, non-regenerative mixed-bed ion exchange device 24, and ultrafiltration membrane device 25. For this reason, a description of detailed configurations of these devices is omitted, and the detailed configuration of oxidizing substance removal device 10 is described below. The ultrapure water production apparatus in this embodiment is not equipped with a membrane degassing device to remove dissolved gases, but a membrane degassing device may be installed as needed or as a backup.

To oxidizing substance removal device 10, the outlet water from ultraviolet oxidation device 23 is supplied as water to be treated, which contains oxidizing substances. Here, oxidizing substances include at least one of dissolved oxygen and hydrogen peroxide. Oxidizing substance removal device 10 is equipped with catalyst tower (Pd) 11 to which the water to be treated is supplied; and hydrogen (H₂) source 12 that generates hydrogen-containing water to add hydrogen to the water to be treated which is supplied to catalyst tower 11. Hydrogen source 12 can be of any form as long as it can generate water containing hydrogen. For example, a source of a gas dissolution type using a gas dissolution membrane or a source of a direct electrolysis type using an electrolysis cell can be used as hydrogen source 12. In environments where handling hydrogen gas is not desirable, it is preferable to use hydrogen source 12 of the direct electrolysis type. Hydrogen-containing water from hydrogen source 12 is injected into the water to be treated at the inlet side of catalyst tower 11. Hydrogen source 12 and the point of injection of the hydrogen-containing water into the water to be treated constitute the hydrogen adding means for adding hydrogen to the water to be treated. To ensure mixing of the hydrogen-containing water with the water to be treated, mixing unit 13 such as a mixing column or mixing tank may be provided between the point of injection of the hydrogen-containing water into the water to be treated and catalyst tower 11.

Catalyst tower 11 is filled with a platinum group metal-supported catalyst to allow the water to be treated to pass through. An object other than the platinum group metal-supported catalyst, such as an ordinary ion exchange resin or other granular object that does not carry a catalyst, may be packed in catalyst tower 11. When filling the platinum group metal-supported catalyst and other granular objects as packed materials in catalyst tower 11, the platinum group metal-supported catalyst and the granular objects may be mixed and packed as a mixed bed, or they may be packed in a multilayered bed so that each of them forms a layer. In the case of packing in a mixed bed, for example, a mixture of platinum group metal-supported catalyst and cation exchange resin may be packed in catalyst tower 11, a mixture of platinum group metal-supported catalyst and anion exchange resin may be packed in catalyst tower 11, or a mixture of platinum group metal-supported catalyst, cation exchange resin and anion exchange resin may be packed in catalyst tower 11.

In the case of multilayered-bed packing in catalyst tower 11, the layer composed of objects other than the platinum group metal-supported catalysts are called non-catalyst layer, there is no limitation on the order of arrangement of the platinum group metal-supported catalyst layers and the non-catalyst layers in catalyst tower 11. When the non-catalyst layer is composed of ion exchange resin, it may be composed of cation exchange resin, anion exchange resin, or a mixture of cation and anion exchange resins. As an example, a layer of the platinum group metal-supported catalyst is provided upstream and a non-catalyst layer is provided downstream in catalyst tower 11. An additional non-catalytic layer may be added upstream of the layer of the platinum group metal-supported catalyst.

The platinum group metal-supported catalyst (hereinafter simply referred to as “catalyst”) is one in which platinum group metal is supported on a carrier and has the function of decomposing hydrogen peroxide into water and oxygen as shown in the above formula (1) when the catalyst comes into contact with water to be treated containing hydrogen peroxide. Along with that, this catalyst has the function of reacting hydrogen added to the water to be treated by hydrogen adding device 11, i.e., the hydrogen dissolved in the water to be treated, with oxygen dissolved in the water to be treated to generate water according to the above formula (2). The dissolved oxygen removed by the catalyst at this time is both dissolved oxygen derived from oxygen originally dissolved in the water to be treated which is supplied to catalyst tower 11 and dissolved oxygen derived from oxygen generated by the decomposition of hydrogen peroxide. Hereafter, the term “dissolved oxygen in water to be treated” shall include at least one of the above two types of the dissolved oxygen. Catalyst tower 11 can remove oxidizing substances from the water to be treated by bringing the water to be treated containing hydrogen into contact with the catalyst. The water to be treated from which oxidizing substances have been removed by catalyst tower 11 is fed to non-regenerative mixed-bed ion exchange device 24.

An anion exchange resin or anion exchanger is preferred as the carrier in the platinum group metal-supported catalyst from the viewpoint of catalyst preparation and reactivity. The term “platinum group metal” is a generic term for ruthenium (Ru), rhodium (Rh), palladium (Pd), osmium (Os), iridium (Ir) and platinum (Pt). In the present invention, it is preferable to use palladium or platinum as the platinum group metal, and palladium is especially preferred in view of its catalytic activity. In the following, palladium is assumed to be used as the platinum group metal.

Increasing the layer height of the catalyst packed in catalyst tower 11 increases the space in which the reaction takes place and the treatment capacity, enabling the stable production of high-quality ultrapure water. When the platinum group metal is supported on an anion exchange resin to form a platinum group metal-supported catalyst, in order to reduce the hydrogen peroxide concentration in the resulting ultrapure water to 1 μg/L or less, it is preferable that the layer height of the catalyst is, for example, 10 cm or higher, 30 cm or higher is more preferred, 70 cm or higher is furthermore preferred. Assuming that the water to be treated passes through the catalyst in catalyst tower 11 in a downward flow, the layer height of the catalyst is the thickness of the catalyst in the area where the water to be treated effectively passes in the height direction. When objects other than the platinum group metal-supported catalyst, such as ordinary ion exchange resins, are packed together with the platinum group metal-supported catalyst in catalyst tower 11 in a mixed bed or multilayered bed, the layer height of the catalyst here refers to the layer height including those objects other than the catalyst, that is the layer height of the packed objects including the platinum group metal-supported catalyst, which are filled in catalyst tower 11. In order to increase the contact efficiency between the catalyst and dissolved oxygen or dissolved hydrogen and to allow the reaction to proceed efficiently, the space velocity (SV) when the water to be treated is passed through the catalyst packed in catalyst tower 11 can be 30 h⁻¹ or higher, for example. Excessively large space velocities may cause the water to be treated to be discharged from catalyst tower 11 before it has completely reacted. To reduce the hydrogen peroxide concentration in the resulting ultrapure water to 1 μg/L or less, it is preferable to reduce the space velocity to, for example, 1000 h⁻¹ or less.

In catalyst tower 11, as described above, oxidizing substances in water to be treated can be removed by reacting the hydrogen added to the water to be treated, or dissolved hydrogen, with the dissolved oxygen in the water to be treated to generate water. In ultrapure water production apparatuses, there is a strong need to reduce the amount of oxygen dissolved in the produced ultrapure water, or dissolved oxygen, as much as possible. Therefore, it is preferable that the amount of hydrogen added to the water to be treated is greater than the theoretical amount that reacts with the dissolved oxygen in the water to be treated to generate water. However, if the amount of hydrogen added is excessive, the ultrapure water produced will contain a large amount of dissolved hydrogen, which is undesirable from the standpoint of water quality. Therefore, in this embodiment, oxidizing substance removal device 10 is equipped with dissolved hydrogen (DH) meter 14 that measures the dissolved hydrogen concentration in the outlet water of catalyst tower 11. In order to perform control that shortens the start-up time of the ultrapure water production apparatus as described below, it is preferable to also have dissolved oxygen (DO) meter 15 that measures the dissolved oxygen concentration in the outlet water of catalyst tower 11 or water near the point-of-use point 30. Dissolved hydrogen meter 14 and dissolved oxygen meter 15 correspond to the first and second measuring means, respectively. Furthermore, oxidizing substance removal device 10 is equipped with control unit 16 that controls the amount of hydrogen-containing water generated by hydrogen source 12 based on measured values taken by dissolved hydrogen meter 14 and dissolved oxygen meter 15. Specifically, control unit 16 controls the amount of hydrogen-containing water generated in hydrogen source 12 so that the dissolved hydrogen concentration in the outlet water of catalyst tower 11 falls within a predetermined concentration range, thereby controlling the amount of hydrogen added to the water to be treated. This control is called the first additive amount control. When it is desired that the dissolved hydrogen concentration in the resulting ultrapure water is 0.1 μg/L or less, control unit 16 performs control so that the dissolved hydrogen concentration in the outlet water of catalyst tower 11 is also 0.1 μg/L or less. This allows the dissolved hydrogen in the water to be treated flowing out of oxidizing substance removal device 10 to be reduced as much as possible, so that ultrapure water can be produced with extremely low dissolved hydrogen concentration by the ultrapure water production apparatus.

By the way, at the start of operation of an ultrapure water production apparatus, the water existing in the apparatus at this time may contain a large amount of dissolved oxygen. Therefore, it is preferable to add hydrogen excessively to the water to be treated in the initial stage of start-up of the ultrapure water production apparatus without performing the first additive amount control, i.e., before initiating the first additive amount control, and then shift to control based on dissolved hydrogen concentration, i.e., first additive amount control. When excess hydrogen is added, a second additive amount control may be performed to control the amount of hydrogen added based on the dissolved oxygen concentration in the outlet water of catalyst tower 11, and when the dissolved oxygen concentration falls below a predetermined value, the second additive amount control nay be stopped to start the first additive amount control based on the dissolved hydrogen concentration. Alternatively, the amount of hydrogen to be added in excess at the start of operation may be predetermined, and the first additive amount control may be started after a predetermined time from the start of operation has elapsed. By adding an excess amount of hydrogen at startup, dissolved oxygen in the apparatus can be quickly removed, and then shifting to control based on dissolved hydrogen concentration, i.e., the first additive amount control, the time until the ultrapure water obtained reaches the prescribed water quality can be shortened. In addition, platinum group metals, especially palladium, have the property of absorbing hydrogen, and in the early stages of start-up, hydrogen absorption is predominant over the consumption of hydrogen in the reaction with oxygen. Therefore, if the first additive amount control is performed from the initial stage of water flow to catalyst tower 11, the amount of hydrogen used for the reaction with oxygen will decrease, which may reduce the ability to remove oxygen. From this point of view, it is preferable to perform the second additive amount control in oxidizing substance removal device 10 at the startup of the ultrapure water production apparatus. Control unit 16 also performs such control of the amount of hydrogen added at the startup of the ultrapure water production apparatus.

The above describes the application of the present invention to an ultrapure water production apparatus configured as a subsystem, but the water treatment method and device based on the present invention are not limited to those shown in the above embodiments. The water treatment method and device based on the present invention can be widely applied in any field where removal of oxidizing substances while controlling dissolved hydrogen concentration is required. For example, the water treatment method based on the present invention can be applied when municipal water, river water, or even recovered water from various processes is used as water to be treated and oxidizing substances are removed from such water to be treated. In this case, the ultraviolet oxidation treatment does not necessarily need to be performed. In other words, oxidizing substance removal device 10 of the configuration shown in FIG. 1 functions by itself as a water treatment device based on the present invention. Furthermore, if a configuration in which catalyst tower 11 is removed from oxidizing substance removal device 10 is referred to as a hydrogen addition control device, the hydrogen addition control device can be added to an existing water treatment plant with a catalyst tower to remove oxidizing substances while controlling the dissolved hydrogen concentration. Therefore, this hydrogen addition control device itself is also included in the category of the water treatment device according to the present invention.

### EXAMPLES

Next, the invention will be further explained based on Examples and Comparative Examples. For Examples and Comparative Examples, we assembled the apparatus shown in FIG. 2, which corresponds to the oxidizing substance removal device according to the present invention. The apparatus is equipped with: dissolved hydrogen generating device 41 that generates hydrogen-containing water as a hydrogen source; mixing column 43; and catalyst tower 45 filled with a platinum group metal-supported catalyst in which palladium is supported on an anion exchange resin. As dissolved hydrogen generating device 41, Sankan-o® manufactured by Organo Corporation, which generates hydrogen-containing water by a direct electrolysis method, was used. Except as otherwise noted, water to be treated with a dissolved oxygen concentration greater than 0.1 μg/L and less than about 10 μg/L, a hydrogen peroxide concentration greater than 1 μg/L and less than about 45 μg/L, and an overall dissolved oxygen load of 20 to 35 μg/L, including the dissolved oxygen and hydrogen peroxide, flows into mixing column 43 via flow meter (FI) 42 and, and the outlet water from mixing column 43 flows into catalyst tower 45. In catalyst tower 45, water was allowed to flow downward. The hydrogen-containing water from dissolved hydrogen generating device 41 is injected into the water to be treated at the inlet position of mixing column 43 via pump (P) 44. Valve 49 is provided between dissolved hydrogen generating device 41 and pump 44 for discharging the hydrogen-containing water.

To measure the dissolved hydrogen and dissolved oxygen concentrations of the outlet water of catalyst tower 45, dissolved hydrogen meter 46 and dissolved oxygen meter 47, both based on the diaphragm electrode method, are attached to the outlet of the catalyst tower 45 via valve 50. At the outlet of valve 50, there is also valve 51 for discharging the outlet water of the catalyst tower 45. The measured values taken by dissolved hydrogen meter 46 and dissolved oxygen meter 47 are supplied to control unit 48, which controls pump 44 based on these measured values to control the amount of hydrogen-containing water injected into the water to be treated. In each of Examples and Comparative Examples, the goal was to have both dissolved hydrogen and dissolved oxygen concentrations not more than 0.1 μg/L and hydrogen peroxide concentration not more than 1 μg/L with respect to the outlet water from catalyst tower 45. In the accompanying drawings, the dissolved hydrogen (DH), dissolved oxygen (DO), and dissolved hydrogen peroxide (H₂O₂) concentrations in the outlet water of catalyst tower 45 are described as “outlet DH concentration,” “outlet DO concentration,” and “outlet H₂O₂ concentration,” respectively.

### Example 1

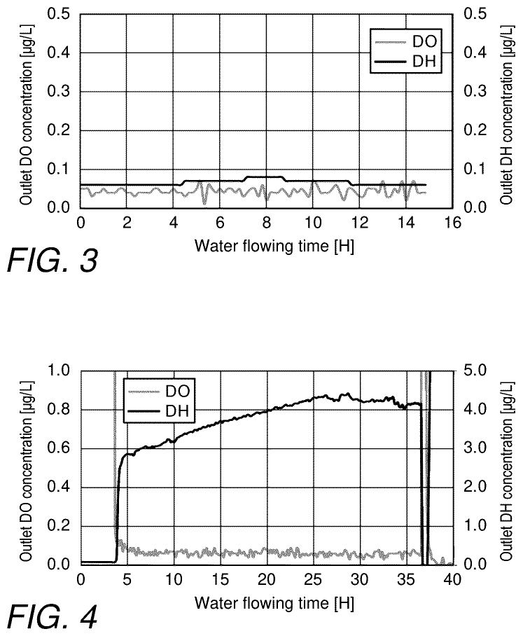

In the apparatus shown in FIG. 2, control unit 48 was used to perform control so that the dissolved hydrogen concentration in the outlet water of catalyst tower 45 is 0.1 μg/L or less, and the time variation in the concentrations of dissolved hydrogen and dissolved oxygen in the outlet water of catalyst tower 45 was examined. The results are shown in FIG. 3. When the hydrogen peroxide concentration of the outlet water from catalyst tower 45 was examined, the hydrogen peroxide concentration was not more than 1.0 μg/L.

### Comparative Example 1

In the apparatus shown in FIG. 2, control unit 48 was used to perform control so that the dissolved oxygen concentration in the outlet water of catalyst tower 45 is 0.1 μg/L or less, and the time variation in the concentrations of dissolved hydrogen and dissolved oxygen in the outlet water of catalyst tower 45 was examined. The results are shown in FIG. 4. The hydrogen peroxide concentration of the outlet water from catalyst tower 45 was not more than 1.0 μg/L.

Comparing Example 1, in which control was based on dissolved hydrogen concentration, with Comparative Example 1, in which control was based on dissolved oxygen concentration, in both cases the hydrogen peroxide concentration could be reduced to 1.0 μg/L or less, achieving the target value. In Example 1, the target values of 0.1 μg/L or less were achieved for both the dissolved hydrogen and dissolved oxygen concentrations, but in Comparative Example 1, the target value was achieved only for the dissolved oxygen concentration, and the dissolved hydrogen concentration settled at a large value of about 4 μg/L or more.

### Example 2

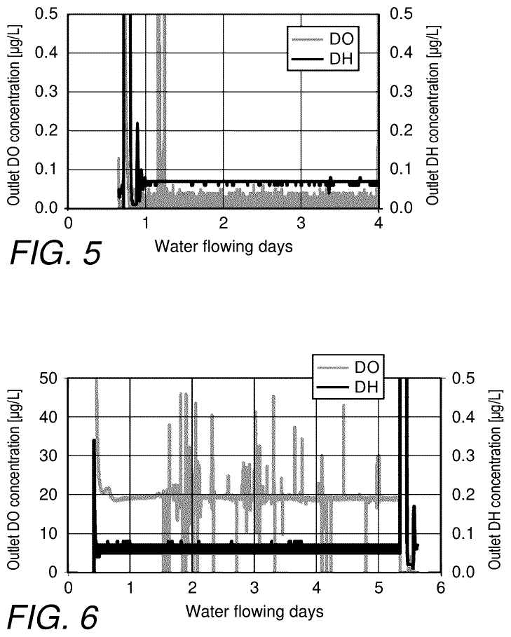

The apparatus shown in FIG. 2 was used to perform control so that the dissolved oxygen concentration is 0.1 μg/L or less, i.e., the second additive amount control, to excessively add hydrogen-containing water at the initial startup of the apparatus, and then the apparatus was switched to perform control so that the dissolved hydrogen concentration is 0.1 μg/L or less, the first additive amount control. The time variation of the dissolved hydrogen and dissolved oxygen concentrations in the outlet water of catalyst tower 45 was examined. The results are shown in FIG. 5. When hydrogen was initially added in excess, the apparatus was able to start up completely within about half a day from the start of water flow.

### Example 3

In the apparatus shown in FIG. 2, the first additive amount control was performed from the initial start-up of the apparatus so that the dissolved hydrogen concentration was 0.1 μg/L or less. The time variation of the dissolved hydrogen and dissolved oxygen concentrations in the outlet water of catalyst tower 45 was examined. The results are shown in FIG. 6. When the first additive amount control was applied from the initial stage of water flow, it took several days or more for the apparatus to start up.

### Example 4

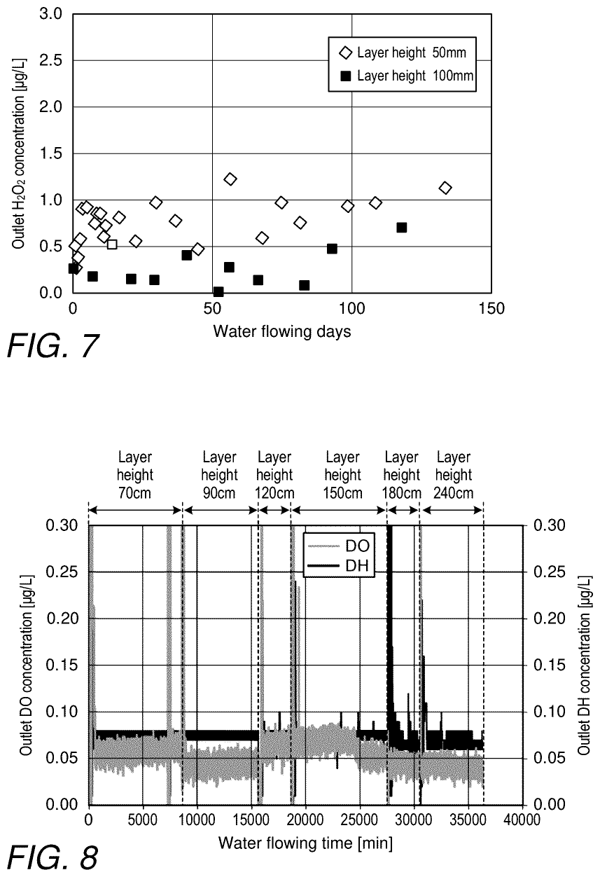

In the apparatus shown in FIG. 2, the relationship between the layer height of the platinum group metal-supported catalyst in catalyst tower 45 and the hydrogen peroxide concentration in the outlet water of catalyst tower 45 was investigated. The layer heights of the catalyst in catalyst tower 45 were 50 and 100 mm. The water to be treated with a hydrogen peroxide concentration of 15 to 20 μg/L was used, and hydrogen was added to the water to be treated while performing control so that the dissolved hydrogen concentration in the outlet water of catalytic tower 45 was 0.1 μg/L or less. The space velocity of the water flow of the water to be treated in catalyst tower 45 was 500 h⁻¹. The results are shown in FIG. 7. It was found that the target value of the hydrogen peroxide concentration, which is not more than 1.0 μg/L, could be met if the layer height of the catalyst in catalyst tower 45 was at least 100 mm.

### Example 5

In the apparatus shown in FIG. 2, water was passed through catalyst tower 45 while changing the layer height of the platinum group metal-supported catalyst in catalyst tower 45 to 70, 90, 120, 150, 180, and 240 cm, and the changes in the dissolved hydrogen and dissolved oxygen concentrations in the outlet water of catalyst tower 45 were examined. Hydrogen was added to the water to be treated by performing control so that the dissolved hydrogen concentration in the outlet water of catalyst tower 45 is 0.1 μg/L or less. The space velocity of the water flow of the water to be treated in catalyst tower 45 was 80 h⁻¹. The results are shown in FIG. 8. At all layer heights, the target values of 0.1 μg/L or less for each of the dissolved hydrogen and dissolved oxygen concentrations were achieved, except at startup and when switching layer heights.

### Example 6

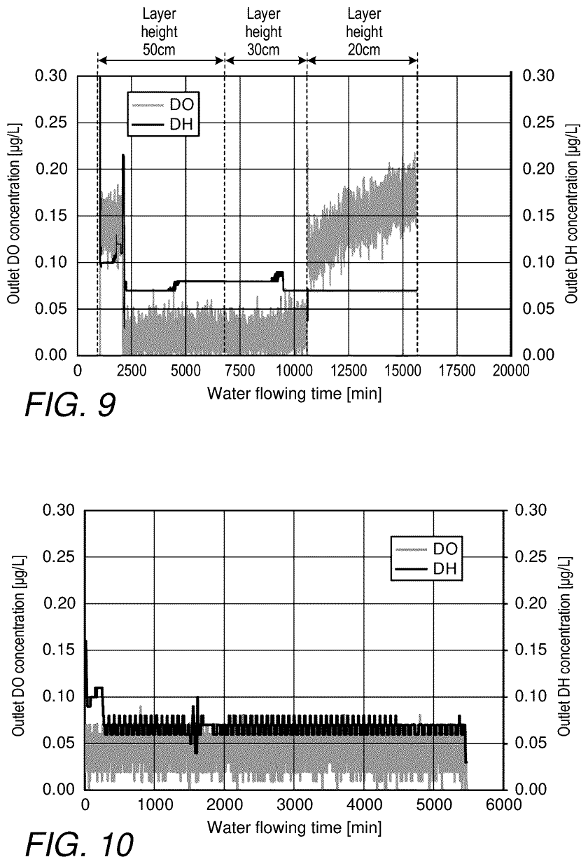

In the apparatus shown in FIG. 2, water was passed through catalyst tower 45 while changing the layer height of the platinum group metal-supported catalyst in catalyst tower 45 to 50, 30, and 20 cm, and the changes in the dissolved hydrogen and dissolved oxygen concentrations in the outlet water of catalyst tower 45 were examined. The water to be treated with a dissolved oxygen concentration of about 10 μg/L and hydrogen peroxide concentration of 30 to 60 μg/L was used, and hydrogen was added to the water to be treated by performing control so that the dissolved hydrogen concentration at the outlet water of catalyst tower 45 is 0.1 μg/L or less. The space velocity of the water flow of the water to be treated in catalyst tower 45 was 100 h⁻¹. The results are shown in FIG. 9. When comparison was made for a period where the outlet concentration was stable, excluding the startup of the system and when switching layer heights, the target values of 0.1 μg/L or less for each of the dissolved hydrogen and dissolved oxygen concentrations in the outlet water of catalyst tower 45 could be achieved if the layer height of the platinum group metal-supported catalyst was 30 cm or higher. When the layer height was 20 cm, the target value for the dissolved hydrogen concentration was achieved, but the target value for dissolved oxygen concentration could not be achieved. With regard to all layer heights, the goal of a hydrogen peroxide concentration, which is not more than 1 μg/L, in the outlet water of catalyst tower 45 was achieved. From the results of Examples 4, 5, and 6, it has been found that the layer height of the catalyst in catalyst tower 45 is preferably 10 cm or more from the viewpoint of removing at least dissolved hydrogen and hydrogen peroxide, and from the viewpoint of removing dissolved oxygen in addition to dissolved hydrogen and hydrogen peroxide, 30 cm or more is more preferable, and 70 cm or more is furthermore preferable.

### Example 7

In the apparatus shown in FIG. 2, the water to be treated was passed through catalyst tower 45 at a space velocity of water flow of 30 h⁻¹ while performing control so that the dissolved hydrogen concentration is 0.1 μg/L or less, and the changes in the dissolved hydrogen and dissolved oxygen concentrations at the outlet water of catalytic tower 45 were examined. The results are shown in FIG. 10. Both dissolved hydrogen and dissolved oxygen concentrations could be not more than 0.1 g/L even when the space velocity was 30 h⁻¹.

### REFERENCE SIGNS LIST

10 Oxidizing substance removal device;
11, 45 Catalyst tower (Pd);
12 Hydrogen (H₂) source;
13 Mixing unit (MIX);
14, 46 Dissolved hydrogen (DH) meter;
15, 47 Dissolved oxygen (DO) meter;
16, 48 Control unit;
20 Tank;
21, 44 Pump;
22 Heat exchanger (HE);
23 Ultraviolet oxidation device (UV);
24 Non-regenerative mixed-bed ion exchange device (CP);
25 Ultrafiltration membrane device (UF);
26 Circulation piping;
30 Point-of-use (POU);
41 Dissolved hydrogen generating device;
42 Flowmeter (FI);
43 Mixing column; and
49 to 51 Valve.

1. A water treatment device comprising an oxidizing substance removal device that removes an oxidizing substance from water to be treated,
wherein the oxidizing substance removal device comprises:
hydrogen adding means that adds hydrogen to the water to be treated;
a catalyst tower equipped with a platinum group metal-supported catalyst through which the water to be treated to which hydrogen has been added passes;
a control unit that controls an amount of hydrogen added by the hydrogen adding means; and
first measuring means that measures a dissolved hydrogen concentration in outlet water of the catalyst tower,
wherein a layer height of a packed material in the catalyst tower, including the platinum group metal-supported catalyst, is 10 cm or more, and
wherein the control unit performs a first additive amount control that controls the amount of hydrogen added by the hydrogen adding means so that a measured value by the first measuring means is within a first range.

2. The water treatment device according to claim 1, further comprising an ultraviolet oxidation device,
wherein the water to be treated is outlet water of the ultraviolet oxidation device.

3. The water treatment device according to claim 1, wherein the platinum group metal-supported catalyst is a catalyst in which at least a platinum group metal is supported on an anion exchange resin, and the platinum group metal-supported catalyst is packed in the catalyst tower.

4. A water treatment device for adding hydrogen to water to be treated that is passed through a catalyst tower equipped with a platinum group metal-supported catalyst, the water treatment device comprising:
hydrogen adding means that adds hydrogen to the water to be treated;
a control unit that controls an amount of hydrogen added by the hydrogen adding means; and
first measuring means that measures a dissolved hydrogen concentration in outlet water of the catalyst tower,
wherein a layer height of packed material in the catalyst tower, including the platinum group metal-supported catalyst, is 10 cm or more, and
wherein the control unit performs a first additive amount control that controls the amount of hydrogen added by the hydrogen adding means so that a measured value by the first measuring means is within a first range.

5. The water treatment device according to claim 1, wherein the control unit controls the hydrogen adding means to add hydrogen in excess without performing the first additive amount control, and, at a predetermined timing, starts the first additive amount control.

6. The water treatment method according to claim 1, further comprising second measuring means that measures a dissolved oxygen concentration of the outlet water of the catalyst tower or water at a point-of-use,
wherein the control unit performs a second additive amount control that controls the amount of hydrogen added by the hydrogen adding means so that a measured value by the second measuring means is within a second range, and, after the measured value by the second measuring means becomes within the second range, stops the second additive amount control to start the first additive amount control.

7. A water treatment method comprising an oxidizing substance removal step that removes an oxidizing substance from water to be treated,
wherein the oxidizing substance removal step comprises steps of: adding hydrogen to the water to be treated; and passing the water to be treated to which hydrogen has been added through a catalyst tower equipped with a platinum group metal-supported catalyst,
wherein, in the step of adding hydrogen, a first additive amount control is performed to control an amount of hydrogen added to the water to treated so that a dissolved hydrogen concentration in outlet water of the catalyst tower is within a first range, and
wherein, in the catalyst tower, a layer height of a packed material in the catalyst tower, including the platinum group metal-supported catalyst, is 10 cm or more.

8. The water treatment method according to claim 7, wherein the water to be treated to which hydrogen is excessively added is passed through the catalyst tower before the first addition volume control is performed, and the first addition volume control is initiated at a predetermined timing.

9. The water treatment method according to claim 7, wherein a second additive amount control to control the amount of hydrogen added to the water to be treated is performed so that a dissolved oxygen concentration in the outlet water of the catalyst tower is in a second range, and after the dissolved oxygen concentration in the outlet water of the catalyst tower reaches the second range, the second additive amount control is stopped and the first additive amount control is started.

10. The water treatment method according to claim 7, wherein the water to be treated to which hydrogen is added is passed through the catalyst tower so that a space velocity with regard to the platinum group metal-supported catalyst is 30 h⁻¹ or higher.

11. The water treatment device according to claim 4, wherein the control unit controls the hydrogen adding means to add hydrogen in excess without performing the first additive amount control, and, at a predetermined timing, starts the first additive amount control.

12. The water treatment method according to claim 4, further comprising second measuring means that measures a dissolved oxygen concentration of the outlet water of the catalyst tower or water at a point-of-use,
wherein the control unit performs a second additive amount control that controls the amount of hydrogen added by the hydrogen adding means so that a measured value by the second measuring means is within a second range, and, after the measured value by the second measuring means becomes within the second range, stops the second additive amount control to start the first additive amount control.
